(19) United States
(12) Patent Application Publication
(10) Pub. No.: US 2006/0208214 A1
(43) Pub. Date: Sep. 21, 2006

(54) Valve and method of manufacturing the same

(75) Inventors: Satoru Okada, Gifu-ken (JP); Kiyotaka Kasugai, Gifu-ken (JP); Hiroyuki Kuze, Gifu-ken (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Pacific Industrial Co., Ltd.

(21) Appl. No.: 11/135,583

(22) Filed: May 23, 2005

(30) Foreign Application Priority Data
Mar. 17, 2005 (JP) 2005-076381

(51) Int. Cl. F16K 25/00

(52) U.S. Cl. 251/368

(57) ABSTRACT

A valve for charging and purging a refrigerant into and out of an air conditioner, for example, includes a body with a hollow interior, a valve port defined in the body, a valve seat provided around the valve port and a ball provided in the body so as to be brought into contact with and parted from the valve seat so that the valve port is closed and opened. The ball is made from ceramic.

### BACKGROUND OF THE INVENTION

1. Field of the Invention

The present invention relates to a valve in which a ball is brought into contact with and parted from a valve seat so that a valve port is closed and opened and a method of manufacturing the valve.

2. Description of the Related Art

Conventional valves of the above-described type have generally been provided with steel balls. JP-A-2002-81562 discloses one of conventional valves with such a steel ball, for example. In valves, such as relief valves or charge valves, used for charging or releasing a refrigerant (CO₂) of a CO₂ air conditioner, both ball and valve seat are made of a metal in order that high-pressure refrigerant may be contained. The metallic ball and valve seat thus provide a metal seal structure.

In the above-described valves, the ball necessitates sphericity since a part of the ball abutting against the valve seat can change from one to another every time the ball is brought into contact with and parted from the valve seat. However, a sufficient sphericity cannot be achieved from a ball made from steel. This can result in a problem of refrigerant leakage in the CO₂ air conditioners.

Furthermore, in order that the tightness may be improved between the ball and the valve seat, the ball needs to be pressed against the valve seat so that an annular dent is formed on the valve seat. However, when the dent is formed on the valve seat, there is a possibility that the ball may be deformed. As a result, the sphericity of the ball is lowered. In view of this problem, a ball made from steel having a high hardness has conventionally been used to form a dent and thereafter replaced by another ball for use as the valve element. Consequently, the valves cannot be manufactured efficiently.

### SUMMARY OF THE INVENTION

Therefore, an object of the present invention is to provide a valve which can achieve a higher sealing performance during closure of the valve and a method of manufacturing the valve more efficiently.

The present invention provides a valve including a body with a hollow interior, a valve port defined in the body, a valve seat provided around the valve port and a ball provided in the body so as to be brought into contact with and parted from the valve seat so that the valve port is closed and opened, wherein the ball is made from ceramic.

The sphericity of the ball can be increased as compared with the conventional steel ball since the ball is made from ceramic. Accordingly, since the ball stably adheres to the valve, the sealing performance can be improved in the closed state of the valve. More specifically, in one embodiment, the ball has a sphericity set to a value smaller than 0.2 μm. Furthermore, the ceramic material may include silicon carbide, alumina, titanium carbide, aluminum nitride and silicon nitride (Ni₃S₄). Of these materials, silicon nitride is preferred.

A surface roughness of the ball can be improved as compared with the conventional steel ball when the ball is made from ceramic. The surface roughness of the ball is set to a value smaller than Ra 0.03 μm.

The valve seat has an annular contact surface with which the ball is brought into a face-to-face contact.

The invention also provides a method of manufacturing a valve including a body with a hollow interior, a valve port defined in the body, a valve seat provided around the valve port and a ball provided in the body so as to be brought into contact with and parted from the valve seat so that the valve port is closed and opened. The method comprises pressing a ball made from ceramic against the valve seat, thereby forming a ball contact surface which is an annular dent and using the ball as a valve element closing and opening the valve port.

The ceramic ball is harder to deform than the steel ball. Accordingly, when the dent or ball contact surface is formed on the valve seat using the ceramic ball, the ceramic ball can serve as the valve element. Consequently, the valve can be manufactured efficiently.

### BRIEF DESCRIPTION OF THE DRAWINGS

Other objects, features and advantages of the present invention will become clear upon reviewing the following description of the embodiment with reference to the accompanying drawings, in which:

FIG. 1 is a sectional view of a valve of a first embodiment in accordance with the present invention;

FIG. 2 is a sectional view of the valve in an open state;

FIG. 3 is a partially enlarged section of a valve seat;

FIG. 4 is a sectional view of a valve of a second embodiment in accordance with the present invention;

FIG. 5 is a sectional view of the valve in an open state; and

FIG. 6 is a sectional view of the valve of a modified form.

### DETAILED DESCRIPTION OF THE INVENTION

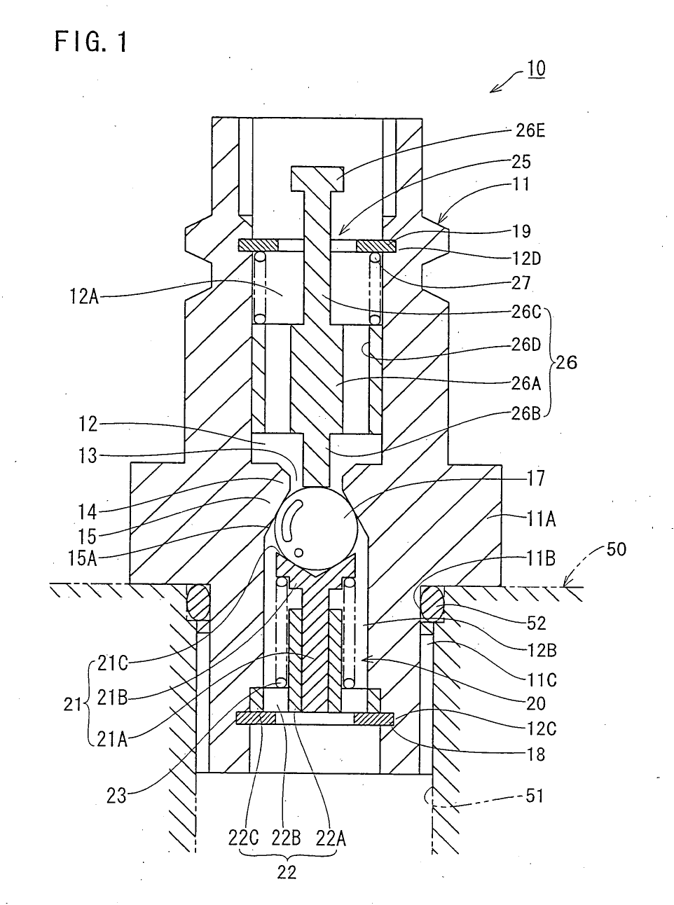

One embodiment of the present invention will be described with reference to FIGS. 1 to 3. Referring to FIG. 1, a valve 10 of the embodiment includes a valve body 11 formed into a generally vertically elongated shape. The valve body 11 has a tool lock 11A formed so as to protrude outward from an outer periphery near a lower end thereof. A seal attaching portion 11B and a male thread 11C are formed below the tool lock 11A on the outer periphery of the valve body 11 in turn. The male thread 11C is screwed into a refrigerant passage 51 of a CO₂ air conditioner 50 (hereinafter, “air conditioner 50”), for example. An O-ring 52 is depressed between the seal attaching portion 11B and an opening edge of the refrigerant passage 51. The tool lock 11A has a hexagonal cross section, for example.

The valve body 11 has a hollow interior serving as a flow passage 12. A valve port 13 is formed by narrowing down an inner peripheral wall 14 of the flow passage 12. A lower part of the wall 14 surrounding the valve port 13 serves as a valve seat 15 as viewed in FIG. 1. A part of the flow passage 12 located over the valve port 13 serves as an outer releasing chamber 12A. The peripheral wall 14 rises up at a right angle to the inner peripheral surface of the outer chamber 12A.

A part of the flow passage 12 located below the valve port 13 serves as an inner releasing chamber 12B. The valve seat 15 is provided with a tapered face 15A having a diameter gradually reduced from the inner releasing chamber 12B toward the valve port 13. In the inner releasing chamber 12B are provided a ball 17 serving as a valve element opening and closing the valve port 13 and a ball push-up mechanism 20 pushing the ball 17 against the valve seat 15 from below. The ball push-up mechanism 20 includes a base 22 fixed to the inner surface of the flow passage 12, a moving portion 21 movably supported on the base 22 and a compression coil spring 23 provided between the moving portion 21 and the base 22. The base 22 includes a hollow cylindrical member 22A and a plurality of spokes 22B protruding sideways from the lower end of the cylindrical member 22A. The spokes 22B have distal ends connected to a base ring 22C concentric with the cylindrical member 22A. The flow passage 12 has a lower open end stepped so that a diameter thereof is increased. A C-ring groove 12C is formed so as to be located below the stepped portion. A C-ring 18 is engaged with the C-ring groove 12C, and the base ring 22C is held between the C-ring 18 and the stepped portion.

The moving portion 21 includes a shaft 21A and a ball holder 21B formed on an upper end of the shaft 21A. The ball holder 21B has an upper surface formed with a conically tapered face 21C. The shaft 21A is fitted in the cylindrical member 22A so as to be movable. The compression coil spring 23 is disposed between the ball holder 21B and the spokes 22B so as to be expanded. As a result, the ball push-up mechanism 20 receives the ball 17 on the tapered face 21C of the ball holder 21B and further presses the ball 17 against the valve seat 15 from below.

A forced valve opening mechanism 25 is provided in the outer releasing chamber 12A of the flow passage 12. The forced valve opening mechanism 25 includes a push pin 26 movable in the outer releasing chamber 12A, a compression coil spring 27 biasing the push pin 26 toward the ball 17 and a C-ring 19 positioning one end of the compression coil spring 27. The push pin 26 includes a column 26A and shafts 26B and 26C protruding from central portions of both ends of the column 26A respectively. The column 26A has a plurality of fluid vents 26D formed around the central portion thereof. The fluid vents extend through the column 26A. A C-ring groove 12D is formed near the upper end in the outer releasing chamber 12A. The C-ring 19 is engaged in the C-ring groove 12D. The compression coil spring 27 is expanded between the upper face of the push pin 26 and the underside of the C-ring 19 thereby to bias the push pin 26 downward, whereby the distal end of the lower shaft 26B is pressed against the ball 17. The compression coil spring has a smaller spring force than the compression coil spring 23 of the aforesaid ball push-up mechanism 20. Accordingly, the ball 17 is normally pressed against the valve seat 15, and the push pin 26 is pressed against the ball 17. The upper shaft 26C has a head 26E formed by increasing the diameter of an upper end thereof.

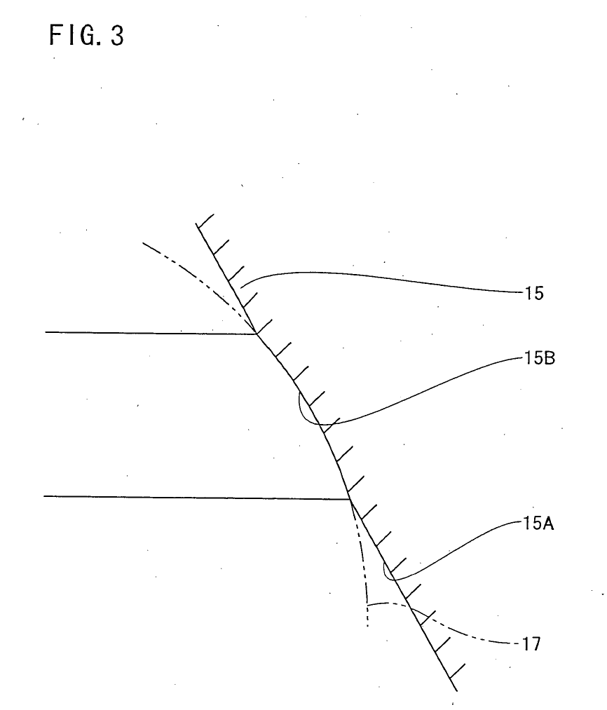

The ball 17 is made from ceramic. The ceramic comprises silicon nitride (Si₃N₄). More specifically, the ceramic composing the ball 17 is made by sintering a predetermined grain diameter of silicon nitride so as to have a nonporous structure. The ball 17 has a sphericity set to 0.13 μm, a surface roughness set to Ra 0.02 μm and a hardness of Hv 1600. On the other hand, the valve body 11 is made from a metal (brass or aluminum, for example). The tapered face 15A of the valve seat 15 is formed with a ball contact face 15B which is an annular dent with which the ball 17 is brought into a face-to-face contact as shown in FIG. 3.

The following describes a method of manufacturing the valve 10 constructed as described above. Firstly, a jig (not shown) is fixed to the valve body 11 (see FIG. 1) so that the ball 17 is accommodated in the inner releasing chamber 12B in the flow passage 12 of the valve body 11. The ball 17 is then pressed against the tapered face 15A by a pressing apparatus (not shown) so that a part of the outer surface of the ball 17 is engaged in the tapered face 15A. Consequently, a dent resulting from the engagement is formed as an annular ball contact face 15B as shown in FIG. 3. Accordingly, the ball contact face 15B has the same curvature and is widthwise rounded as the ball 17. Since the ball 17 is made from the ceramic, the ball 17 is hard to be deformed even when used to form the dent as the ball contact face 15B. Accordingly, the ball 17 having been used to form the dent is maintained in the inner releasing chamber 12B in order to serve as the valve element.

Subsequently, the compression coil spring 23 is disposed around the cylindrical member 22A of the base 22, and the shaft 21A of the moving portion 21 is disposed inside the cylindrical member 22A, whereby the ball push-up mechanism 20 is assembled. The entire ball push-up mechanism 20 is fitted in the inner releasing chamber 12B, and the base ring 22C is abutted against the stepped portion of the inner wall of the chamber 12B. The C-ring 18 is then engaged in the C-ring groove 12C. Consequently, the ball 17 is held in the inner releasing chamber 12B together with the ball push-up mechanism 20.

Subsequently, the push pin 26 and the compression coil spring 27 are disposed in the outer releasing chamber 12A side in the flow passage 12 and thereafter, the C-ring 19 is engaged in the C-ring groove 12D. The valve 10 is thus completed. According to the foregoing valve manufacturing method, the ball 17 used to form the ball contact face 15B in the valve seat 15 is also used as the valve element opening and closing the valve port 13. Consequently, the valve 10 can be manufactured by the foregoing method more efficiently than by the conventional method in which two different balls are employed for the respective uses.

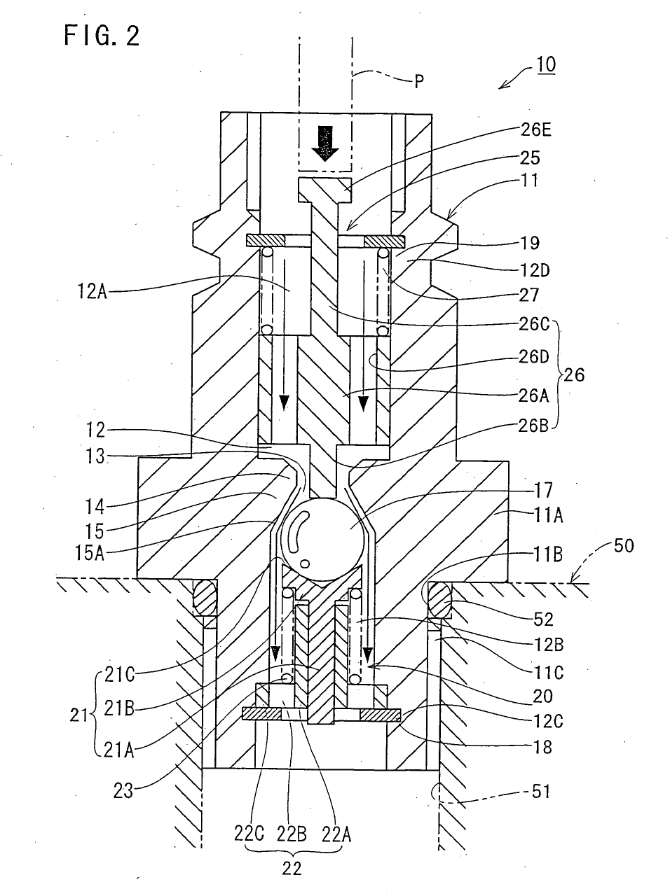

The operation of the valve will now be described. For example, the valve 10 is screwed into the refrigerant passage 51 of the air conditioner 50 to be fixed in position, whereby the opening of the refrigerant passage 51 is closed by the valve 10. In order that a refrigerant (CO₂, for example) may be charged into the air conditioner 50, a refrigerant supply nozzle (not shown) is joined to the upper open end of the valve 10 so that a compressed fluid or refrigerant is supplied from the nozzle into the flow passage 12 of the valve 10. More specifically, the push pin 26 is pushed downward by a push rod P attached to the nozzle (see FIG. 2) so that the valve port 13 is forcedly opened. The refrigerant passage 51 is then evacuated and thereafter, refrigerant is charged into the refrigerant passage 51.

The nozzle is removed from the valve 10 when the refrigerant in the air conditioner 50 has reached a predetermined pressure. The ball 17 is pressed against the valve seat 15 primarily by an inner pressure of refrigerant in the air conditioner 50. A part of the ball 17 is then brought into face-to-face contact with the ball contact face 15B of the valve seat 15, whereby seal is provided between the ball 17 and the valve seat 15. As a result, the valve port 13 is closed. The ball 17 is disengaged from the valve seat 15 every time the valve 10 is opened and closed. A part of the ball 17 brought into contact with the valve seat 15 can change from one to another. However, since the ball 17 is made from ceramic in the foregoing embodiment, the sphericity of the ball 17 is improved as compared with the conventional steel ball. Accordingly, the ball 17 is adherent to the valve seat 15 more stably. Consequently, the sealing performance of the valve 10 in the closed state of the valve can be improved and accordingly, an amount of refrigerant leakage can be reduced as compared with the conventional valve. Moreover, since the hardness of the ball 17 is also improved, wear resistance of the ball 17 can be improved, whereupon the reliability of the valve can also be improved.

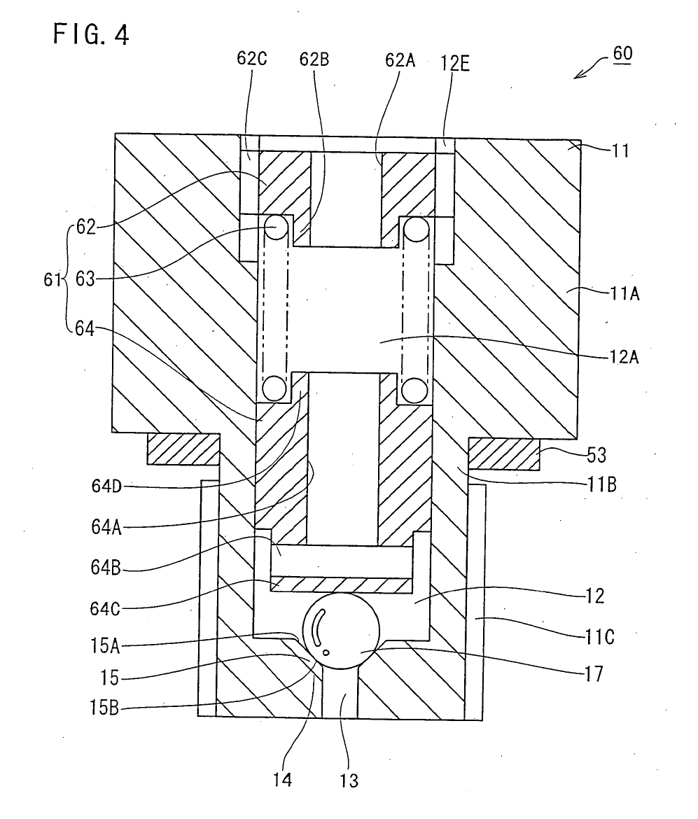

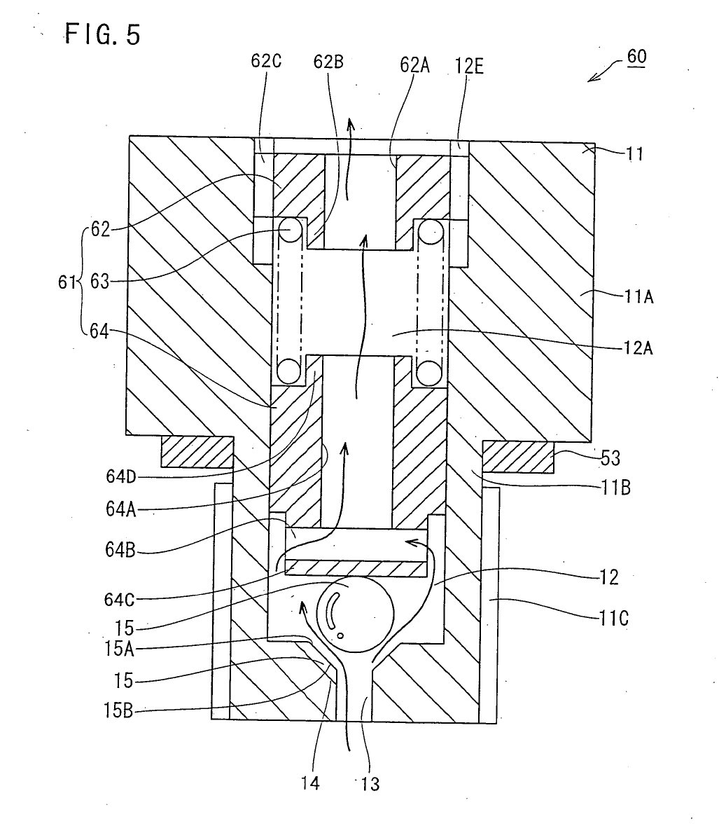

FIGS. 4 and 5 illustrate a second embodiment of the invention. The valve 60 of the second embodiment includes the valve body 11 having a tool lock 11A. A packing 53 is provided on the underside of the tool lock 11A. The male thread 11C protrudes downward from a central underside of the tool lock 11A as viewed in FIG. 4. The male thread 11C is screwed into the refrigerant passage of the air conditioner (see-FIG. 1) so that the valve 60 is fixed to the air conditioner while the packing 53 is depressed.

The valve port 13 is provided in the lower end of the flow passage 12. An upper part of the peripheral wall 14 defining the valve port 13 serves as the valve seat 15. The ball 17 is disposed over the valve seat 15. A ball push-down mechanism 61 is provided over the ball 17. The ball push-down mechanism 61 includes a moving member 64 moved in the outer releasing chamber 12A, a compression coil spring 63 biasing the moving member 64 toward the ball 17 and a cylindrical member 62. The compression coil spring 63 is held between the moving member 64 and the cylindrical member 62.

The moving member 64 is formed generally into a cylindrical shape and has opposite ends formed with smaller-diameter portions 64C and 64D respectively. A first vent hole 64B is defined in the smaller-diameter portion 64C of the lower end of the moving member 64. The first vent hole 64B extends radially through the smaller-diameter portion 64C. A second vent hole 64A is defined in the central interior of the moving member 64. An upper open end of the second vent hole 64A is open to the upper end of moving member 64 whereas a lower open end of the second vent hole 64A communicates with the first vent hole 64B. The cylindrical member 62 is formed generally into a cylindrical shape and has a lower end formed with a smaller-diameter portion 62B. The cylindrical member 62 has a centrally formed through hole 62A. The cylindrical member 62 further has a male thread 62C formed on an outer periphery thereof. A female thread 12E is formed on an open edge of the flow passage 12. The male thread 62C of the cylindrical member 62 is engaged with the female thread 12E so that the cylindrical member 62 is fixed to the valve body 11.

The coil spring 63 is held between the cylindrical member 62 and the moving member 64 so as to be compressed, whereupon the moving member 64 is biased downward and the ball 17 is pressed against the valve seat 15. The coil spring 63 has both ends fitted with the smaller-diameter portion 62B of the cylindrical member 62 and the smaller-diameter portion 64D of the moving member 64 respectively.

The construction other than described above is the same as that in the first embodiment. Accordingly, identical or similar parts in the second embodiment are labeled by the same reference symbols as those in the first embodiment and description of these parts are eliminated.

When the fluid pressure in a space between the ball 17 and the valve port 13 side is increased to a value larger than a predetermined one, the ball 17 is parted from the valve seat 15 against the spring force of the coil spring 63 by the fluid pressure as shown in FIG. 5. As a result, the valve port 13 is opened such that the fluid is discharged. Furthermore, since the ball 17 is made from ceramic as in the first embodiment, the second embodiment can achieve the same effect as the first embodiment.

The valve 60 of the above-described second embodiment was manufactured. A conventional valve was also manufactured. The conventional valve included a ball made from stainless steel (SUS440C, for example). A performance evaluation test was conducted regarding the valve 60 of the second embodiment and the conventional valve. The evaluation depended upon whether a criterion of environmental protection was met. More specifically, regarding the environmental protection, there is provided a criterion that concerning a refrigerant of an air conditioner or the like, an amount of fluid leakage in a year needs to be not more than 0.5 g when a valve is subjected to fluid pressure of 11 MPa. In the test, the fluid pressure of 11 MPa was applied to the space between the ball 17 and the valve port 13 side of each of the embodiment and conventional valves. An amount of leakage per predetermined time was obtained. The obtained amount of leakage was converted to a total amount of fluid leakage per year. The obtained total amount of fluid leakage was compared with the aforesaid criterion.

TABLE 1

| | | | Conventional |
|---|---|---|---|
| | | Embodiment | product |
| Material for ball | | ceramic (Si3N4) | stainless steel |
| | | | (SUS440C) |
| Accuracy | Sphericity | 0.13 μm | 0.7 μm |
| (catalog | Surface roughness | Ra 0.02 μm | Ra 0.05 μm |
| value) | Hardness | Hv 1600 | Hv 800 |

| | | |
|---|---|---|
| Results of evaluation test | | |
| Airtight pressure of 11 MPa | 0.032 cc/hour | A large amount |
| (used gas: CO₂) | or below → 0.5 | of gas leaked |
| | g/year or below | in a range from |
| | | 2 to 4 MPa. |
| | | Pressure was not |
| | | able to be |
| | | increased to 11 |
| | | MPa. |

As shown in TABLE 1, in the conventional product, an amount of refrigerant leaking was increased when the fluid pressure in the space between the ball 17 and the valve port 13 side reached a range from 2 to 4 MPa. As a result, the fluid pressure was not able to be increased to 11 MPa. In the embodiment, however, the fluid pressure was able to be increased to 11 MPa. An amount of fluid leakage per hour was 0.032 cc under the condition of fluid pressure of 11 MPa. When the amount of fluid leakage per hour was converted to a total amount of leakage per year, a value of 0.5 g or below was obtained. This value met the above-described criterion of environmental protection. Furthermore, the sphericity, surface roughness and hardness of the ball 17 made from ceramic were improved as compared with those of the conventional stainless steel ball as shown in TABLE 1. Consequently, the improvement in the sphericity of the ceramic ball 17 can be considered to improve the sealing performance of the valve.

The invention should not be limited to the foregoing embodiments. For example, the following modified forms may be included in the technical scope of the invention.

In the first embodiment, the ball 17 is pressed against the valve seat 15 by the ball push-up mechanism 20. However, the invention may be applied to a valve in which the ball 17 is pressed against the valve seat only by the pressure of the refrigerant without provision of the ball push-up mechanism.

In each foregoing embodiment, the ball 17 is made from the ceramic comprising silicon nitride. For example, the ball 17 may be made from ceramic comprising silicon carbide, alumina, titanium carbide or aluminum nitride. However, it is preferable to make the ball from ceramic comprising silicon nitride as in the foregoing embodiments. The reason for this is that silicon nitride has a relatively higher covalent bonding property and smaller thermal expansion coefficient.

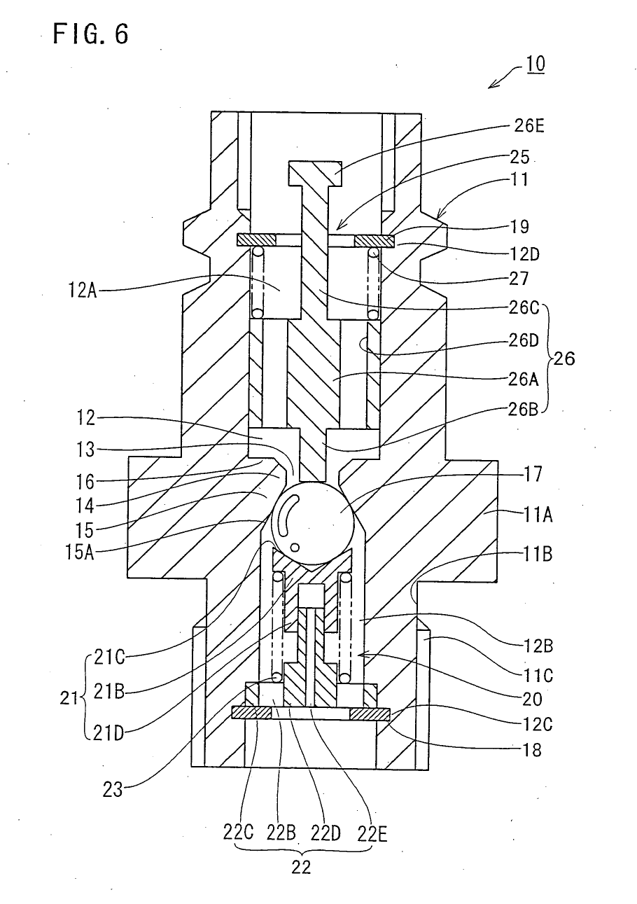

The shaft 21A of the moving portion 21 is fitted in the cylindrical member 22A of the base 22 in the first embodiment. However, as shown in FIG. 6, a support column 22D may be provided on the center of the base 22. The support column 22D may be formed with a central vent hole 22E. The moving portion 21 may be provided with a cylindrical portion 21D. The cylindrical portion 21D may be fitted with the outer periphery of the support column 22D.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A valve including a body with a hollow interior, a valve port defined in the body, a valve seat provided around the valve port and a ball provided in the body so as to come into contact with and depart from the valve seat so that the valve port is closed and opened, wherein the ball is made from ceramic.

2. The valve according to claim 1, wherein the ceramic comprises silicon nitride.

3. The valve according to claim 2, wherein the ball has a sphericity set to a value smaller than 0.2 μm.

4. The valve according to claim 2, wherein the ball has a surface roughness set to a value smaller than Ra 0.03 μm.

5. The valve according to claim 3, wherein the ball has a surface roughness set to a value smaller than Ra 0.03 μm.

6. The valve according to claim 1, wherein the valve seat has an annular ball contact surface with which the ball is brought into a face-to-face contact.

7. The valve according to claim 2, wherein the valve seat has an annular ball contact surface with which the ball is brought into a face-to-face contact.

8. The valve according to claim 3, wherein the valve seat has an annular ball contact surface with which the ball is brought into a face-to-face contact.

9. The valve according to claim 4, wherein the valve seat has an annular ball contact surface with which the ball is brought into a face-to-face contact.

10. The valve according to claim 5, wherein the valve seat has an annular ball contact surface with which the ball is brought into a face-to-face contact.

11. A method of manufacturing a valve including a body with a hollow interior, a valve port defined in the body, a valve seat provided around the valve port and a ball provided in the body so as to come into contact with and depart from the valve seat so that the valve port is closed and opened, the method comprising:
pressing a ball made from ceramic against the valve seat, thereby forming a ball contact surface which is an annular dent; and
using the ball as a valve element closing and opening the valve port.
